(19) United States
(12) Patent Application Publication
(10) Pub. No.: US 2016/0078012 A1
(43) Pub. Date: Mar. 17, 2016

(54) SYSTEMS AND METHODS FOR FORMLESS INFORMATION TECHNOLOGY AND SOCIAL SUPPORT MECHANICS

(71) Applicant: BMC SOFTWARE, INC., Houston, TX (US)

(72) Inventors: Christopher F. DAUW, Round Rock, TX (US); Jason W. FRYE, McLean, VA (US); Ting HE, Austin, TX (US); Wesley GERE, Austin, TX (US); Jason L. GRAHAM, Austin, TX (US)

(21) Appl. No.: 14/674,751

(22) Filed: Mar. 31, 2015

Related U.S. Application Data
(60) Provisional application No. 62/048,875, filed on Sep. 11, 2014.

(51) Int. Cl. G06F 17/24; G06F 3/0484; G06F 3/0481; G06F 17/30

(52) U.S. Cl. CPC G06F 17/24; G06F 17/3053; G06F 17/30864; G06F 3/0484; G06F 3/0481; G06F 17/30684

(57) ABSTRACT

A system includes a user interface having a text input box configured to receive input from a user, the input including text and/or an action indicator, and a response area for displaying results and/or action selection buttons in response to the input from the text input box. The system includes an application engine that receives the input from the text input box as a user types each character into the text input box, performs a search and present results to the search in the response area, in response to receiving additional text input from the text input box, performs the search and presents updated results to the search in the response area, and in response to receiving text and an action indicator from the text input box, causes an action corresponding to the action indicator to be performed and causes a change to the user interface corresponding to the action.

### CROSS REFERENCE TO RELATED APPLICATIONS

This application claims the benefit of U.S. Provisional Application No. 62/048,875, filed on Sep. 11, 2014, and titled “Systems and Methods For Formless Information Technology And Social Support Mechanics”, which is hereby incorporated by reference in its entirety.

### TECHNICAL FIELD

This description relates to formless information technology (IT) and social support mechanics.

### BACKGROUND

The average information technology (IT) form for requests or to report incidents to IT is delivered in two columns with row after row of fields. Today's consumer-based applications are streamlined and concise, while enterprise applications remain complex and cumbersome to utilize. The perception of the quality of service IT delivers to the business is adversely affected by this complexity and the mundane laborious form based interactions that users have to go through to get the services or support they need.

### SUMMARY

In one general aspect, a system includes a user interface having a text input box configured to receive input from a user, the input including text and/or an action indicator, and a response area for displaying results and/or action selection buttons in response to the input from the text input box. The system includes an application engine that receives the input from the text input box as a user types each character into the text input box, performs a search and present results to the search in the response area, in response to receiving additional text input from the text input box, performs the search and presents updated results to the search in the response area, and in response to receiving text and an action indicator from the text input box, causes an action corresponding to the action indicator to be performed and causes a change to the user interface corresponding to the action.

Implementations may include one or more of the following features. For example, the application engine may, in response to receiving text only without an action indicator and a submit action, post the text to a social media platform.

The system may further include a search engine and a database of support objects, where the application engine is configured to, in response to receiving the action indicator attached to specific text, cause the search engine to search a list of objects from the database of support objects based on the specific text and present the list of objects for display in the response area of the user interface and selection by the user. The application engine may be configured to auto-complete the specific text with a name of the object associated with the action identifier and assign an identifier to the name of the object for use by the application engine, where the identifier is hidden from the user. The action indicator may determine a type of object for the search engine to search for in the database of support objects. The type of object may include a name object, a category object and a support object, where each of the objects corresponds to a different action indicator.

The system may further include a natural language processing (NLP) engine, where the application engine sends the text input to the NLP engine, the NLP engine is configured to return a tree structure of words and the search engine is configured to search the database of support objects using the tree structure of words.

The system may further include a prioritization engine, where the prioritization engine may be configured to receive results from the search engine and to prioritize the results to order and rank the results and the application engine may be configured to cause the ordered and ranked results to be displayed in the response area of the user interface.

The system may further include a search history and user context database, where the prioritization is configured to use information from the search history and user context database to order and rank the results.

In another general aspect, a computer-implemented method includes executing instructions stored on a non-transitory computer-readable storage medium. The method further includes receiving input from a user in a text input box and the input includes text and/or an action indicator, displaying results and/or action selection buttons in a response area in response to the input from the text input box, receiving the input from the text input box as a user types each character into the text input box, in response to receiving the text input from the text input box, performing a search and presenting results to the search in the response area input is received into the text input box, in response to receiving additional text input from the text input box, performing the search and presenting updated results to the search in the response area and in response to receiving text and an action indicator from the text input box, causing an action corresponding to the action indicator to be performed and causing a change to the user interface corresponding to the action.

Implementations may include one or more of the following features. For example, the computer-implemented method may further include, in response to receiving text only without an action indicator and a submit action, posting the text to a social media platform.

The computer-implemented method may further include, in response to receiving the action indicator attached to specific text, causing a search engine to search a list of objects from the database of support objects based on the specific text and presenting the list of objects for display in the response area of the user interface and selection by the user.

The computer-implemented method may further include auto-completing the specific text with a name of the object associated with the action identifier and assigning an identifier to the name of the object for use by the application engine, where the identifier is hidden from the user.

The computer-implemented method may further include determining a type of object for the search engine to search for in the database of support objects. The type of object may include a name object, a category object and a support object, where each of the objects corresponds to a different action indicator.

The computer-implemented method may further include sending the text input to a natural language processing (NLP) engine, returning a tree structure of words by the NLP engine and searching the database of support objects using the tree structure of words by the search engine.

The computer-implemented method may further include receiving results at a prioritization engine from the search engine and prioritizing the results to order and rank the results and causing the ordered and ranked results to be displayed in the response area of the user interface.

The computer-implemented method may further include ordering and ranking the results using information from a search history and user context database.

In another general aspect, a computer program product is tangibly embodied on a non-transitory computer-readable storage medium and includes executable code that, when executed, is configured to cause at least one processor to receive input from a user in a text input box and the input includes text and/or an action indicator, display results and/or action selection buttons in a response area in response to the input from the text input box, receive the input from the text input box as a user types each character into the text input box, in response to receiving the text input from the text input box, perform a search and present results to the search in the response area input is received into the text input box in response to receiving additional text input from the text input box, perform the search and present updated results to the search in the response area and in response to receiving text and an action indicator from the text input box, cause an action corresponding to the action indicator to be performed and cause a change to the user interface corresponding to the action.

Implementations may include one or more of the following features. For example, the computer program product may further include executable code that, when executed, is configured to cause at least one processor to in response to receiving text only without an action indicator and a submit action, post the text to a social media platform.

### BRIEF DESCRIPTION OF THE DRAWINGS

FIG. 1 is a block diagram of a system for formless IT and social support mechanics.

FIG. 2 is an example screen shot of a user interface.

FIG. 3 is an example screen shot of a user interface.

FIG. 4 is an example screen shot of a user interface.

FIG. 5 is an example screen shot of a user interface.

FIG. 6 is an example screen shot of a user interface.

FIG. 7 is an example flowchart illustrating example operations of the system of FIG. 1.

### DETAILED DESCRIPTION

This document describes systems and techniques that makes getting support and accessing services as easy as using consumer based applications or posting an update to a social media site. Users are given full access to all of the IT services, support, and knowledge but allow them to interact with these tools using concise text-based mechanics. The system puts all of the power of traditional legacy IT tools in the hands of the average non-technical user but does so in a manner that is familiar, intuitive, and easy to utilize.

This document describes a system and techniques that provides an application having a front-end user interface that that enables users to communicate, search, request actions and perform other tasks within the user-interface and that automatically triggers actions using one or more back-end computing devices that host the requested service or task functionality for delivery to the front-end user interface. The application having the front-end user interface may include a single unified text input box or field (also referred to throughout simply as “text input box”) to receive the user input. The received user input may trigger or cause one or more various actions and responses based on the type of input received.

For example, in addition to communicating with help desk experts and colleagues, users can interact with IT in a modern, formless way using the single unified text input box. If the user needs, for example, virtual private network (VPN) access because the user is traveling, the user simply writes a post in the text input box saying exactly that. As the user types into the text input box, the text input box receives the input and passes the input to the back-end computing devices for immediate action. For instance, as the user types into the text input box, the system immediately matches the user's inquiry with knowledge management articles or existing service offerings through a mix of search algorithms and machine learning systems that get smarter the more users interact with the solution.

Also, as the user types into the text input box, a recommendation engine can present the answer the user needs before the user has finished typing the question. The system may be configured automatically to recognize one or more action indicators that, when received in the text input box, trigger specific actions on the back-end as well as automatic transformations of the user interface. The action indicators may include, for instance, characters, special characters, symbols, words and symbols and/or combinations of these. For example, if the user wants to address the post to a specific person, group, or asset, the user simply references them with an “@” symbol. All of the ‘Things’ in the enterprise (hardware, software, people, assets, buildings, facilities, etc) are capable of being referenced in a post using the text input box. Various symbols, which are action indicators, that are input into the text input box may convert simple posts into real ITIL® processes. Furthermore, by adding the words “!Request,” “!Appointment,” or “!Incident” to a post in the input text box, the system automatically converts them into actions for the help desk.

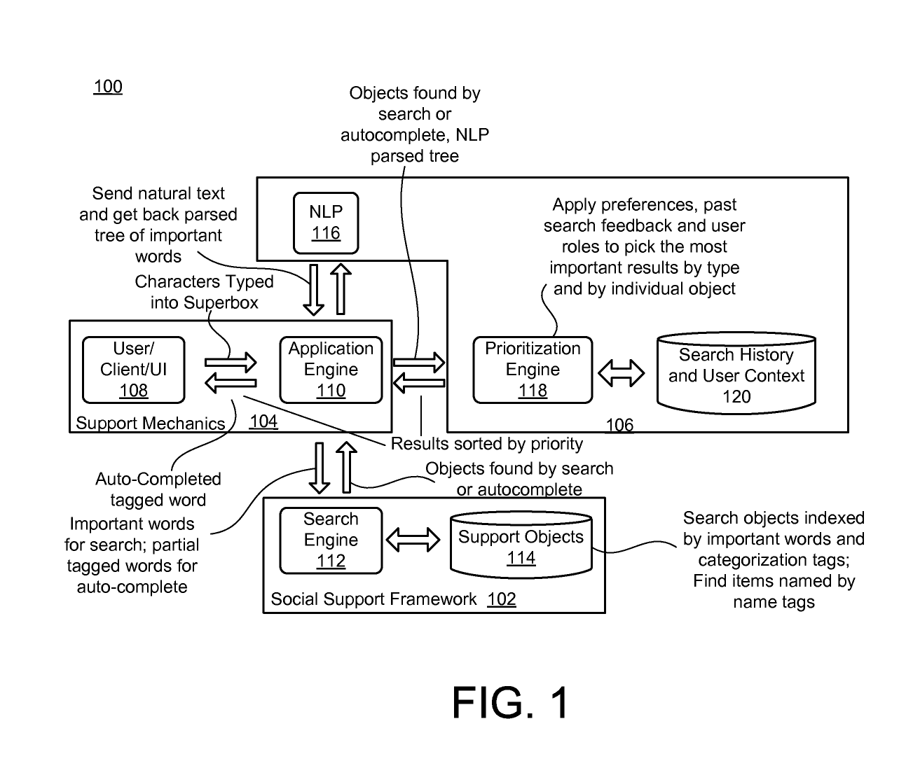

Referring to FIG. 1, an example block diagram illustrates a system 100 for formless IT and social support mechanics. The system 100 includes a single unified text input box/field within an IT-issued corporate application, for the purpose of corporate assistance, that gives search results as a user types, relevant to finding help or solving a problem, and shifting the outside of the text area when the user indicates an action to be taken, using a special character and keyword. The shifted action UI has buttons appropriate to the action indicated by the keyword. If no action is indicated, a general social post is submitted to a corporate social platform.

In the system 100, a special tag character typed by the user indicates a reference to an object in the system, and the UI can auto-complete the name of the reference based on initial characters typed. The completed name of the object contains an ID referencing the object that can be understood by an application engine. The ID is hidden from the user (not visible in the text input), by means of special markup text understood by the UI and the application engine.

In the system 100, the search results are enhanced by using natural language processing for tailoring the search, and prioritized (prioritization resulting in an ordering and highlighting of items in the list of results) based on a) information about the user known by the system; b) the user's history of clicking on certain result items in the past; and c) the wider history of the aggregate user base of the system clicking more often on various search result items.

In the system 100, when user context is known by the system, such as physical location or owned Resources, the user context is automatically added as extra information part of actions submitted by the user through the mechanism.

In the system 100, when the user submits an action, the type of action and the presence of certain pre-configured words and phrases will cause the system to populate certain parameters or properties associated with the action with certain values.

The system 100 includes a social support framework 102, a support mechanics 104, and a recommendation engine 106.

The social support framework 102 includes a search engine 112 and a support objects database 114. The social support framework 102 provides the ability to catalog all of the services, people, places and things within an enterprise. Any and all of these may be a necessary component to business productivity and included under the umbrella of IT support. Everything within the enterprise may become a social support object. Social Support Objects may include the following characteristics: status, actions, subscription, location, organic relationships and timeline. Each of the social support objects may be referenced in the support object database 114.

Social support objects can be included in posts, or referenced in tickets, using the text input box. Social support objects have a status that can be changed by an administrator or end users in the environment to communicate availability. Social support objects also have a set of actions that can be defined like open a ticket or view instruction manual. Also, social support objects have the ability to be subscribed to by users and they can be associated with a location on a floor map. Additionally, these objects can be grouped together. For example, one object might be a conference room, while a child object of the conference room might be a projector or phone system. Each object will have a timeline of events cataloguing the history of the object in the enterprise throughout its lifecycle from creation to decommission, all of which is stored and accessed through the support objects database 114. The timeline will collect pertinent information and will be a collaboration area where users and subject matter experts can post questions and share tips and tricks on the service they use in the enterprise. The search 112 is explained in more detail below.

The support mechanics 104 enables the system to use text based support mechanics to reference and interact with the social support objects in the environment. The support mechanics 104 includes the user interface 108 and the application engine 110. The user interface 108 includes the text input box, as referenced above, to enable the user to input text. The user interface 108 may change dynamically in response to the input text. Through the text input box, the user can post questions, problems and include the relevant object that the issue is pertaining to, all of which leverage the social support framework 102, including the search engine 112 and the support objects database 114. The user interface 108 is the front end interface, which may run on a client computing device. The input into the user interface 108 is communicated to the application engine 110, which then communicates the input and/or generates requests for data and actions from the relevant back-end component(s) including the social support framework 102. The user can crowd source support by posting a question to the group of users subscribed to the service and get real time answers from collaborators and experts without having to contact IT. Alternatively, the user can direct the post to IT detailing the user's need or problem.

The following action indicators when entered into the text input box automatically cause the application engine 110 to perform specific functions. For example, “@” Includes: Ask a question of colleagues or send a ticket to IT, either way the user can reference any person, place, or thing with an @ symbol. For instance, if the user has question on how to use the VPN, the user can include @VPN in the message in the text input box and it will post to the VPN profile page and any user or subject matter expert can add helpful advice.

The action indicator “#” is used for categorization. Instead of navigating a complex taxonomy of Category, Type, Item, etc., the user can chose from trending topics or use their own. In this way, posts and trouble tickets initiated through the text input box can be categorized into topics that can be indexed and sorted as determined by the application engine 110 interfacing with the appropriate back end component, which is configured to perform the functions such as storing, indexing and sorting these items.

The action indicator “!” is user for support. The action indicator “!” may be used in combination with one or more words to specify the type of support that may be needed and/or to direct the support to the correct entity or business unit in the enterprise. For instance, if the user needs to raise an issue, the user may use “!Request”, “!Facilities”, or “!HR” in the text input box to make sure that a post or ticket gets directed to the right business unit.

When a user is typing in the text input box (also referred to as a “superbox” or text input area), the application engine 110 may communicate the received input to the recommendation engine 106. The recommendation engine 106 includes a natural language processing (NLP) engine 116, a prioritization engine 118 and a search history and user context database 120. In response to receiving the input, the recommendation engine 106 may bring back relevant information or knowledge that can help solve the problem using the NLP engine 116, the prioritization engine 118 and the search history and user context database 120. The recommendation engine 106 can return services, conversation topics, or ticket types that will automate the resolution of the issue without having to contact IT via the service desk.

In this manner, the text input box in combination with the application engine 110 and the other services, including the social support framework 102 and the recommendation engine 106, may use formless IT, meaning without a user or IT personnel having to fill in a form with information, to capture all of the technical and institutional memory in an organization. The system 100 allows pertinent knowledge to be captured and updated organically to significantly drive down support costs and remove the need for a Level 1 Service Desk.

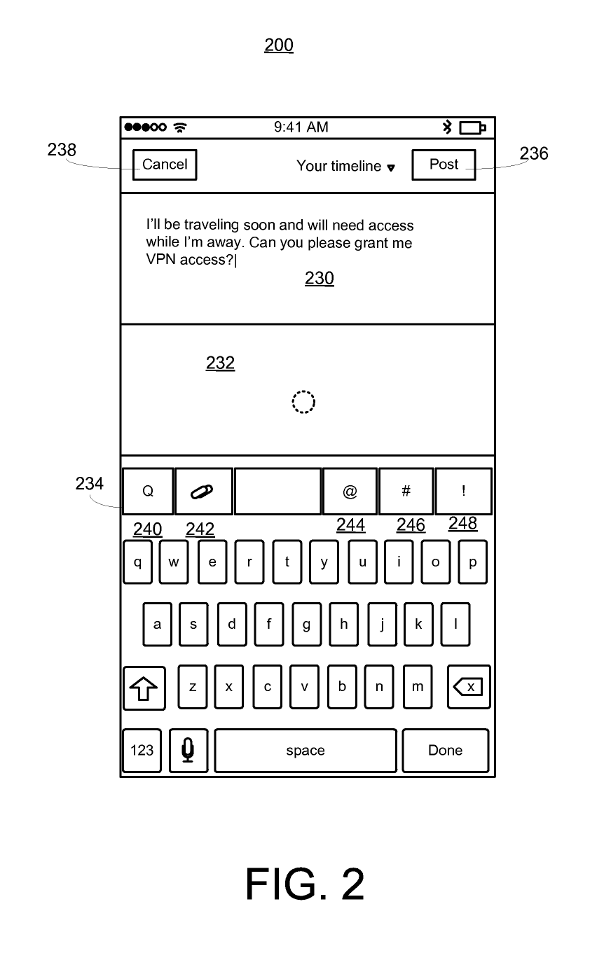

Referring to FIG. 2, an example screen shot illustrates an example user interface 200. The user interface 200 may be presented by the user client/user interface 108. The user interface 200 includes the text input box 230, an response/action area 232, an action indicator selection area 234, a post button 236, and a cancel button 238. The action indicator selection area 234 includes a search button 240, an attachment button 242, an “@” action indicator 244, a “#” action indicator 246 and a “!” action indicator 248. Selection of the search button 240 may cause a search to be performed based on the text entered into the text input box 230 and/or to change the interface to a more specific search user interface. Selection of the attachment button 242 may enable the user to attach one or more files or objects to the posted input. The selection of one of the action indicators 244, 246 or 248 may include the action indicator in the text input box 230 for processing by the application engine 110.

The text input box 230 is a text input on the main user interface screen of the IT support application. Referring back to FIG. 1, the part of the application running on the user's computing device, including any type of computing device such as a desktop, a laptop, a mobile computing device, a smartphone or other computing device, is labelled User/Client/UI 108 in FIG. 1. As the user types in the text input box 230, the typed text is sent to the application engine 110, which is a computer server accessed by the client over a network or the internet. The typed text may be updated to the application engine 110 every time the user types a character in the text input box 230.

When the application engine 110 receives text from the client user interface 108, which could have a partial word as it is updated while the user is typing, the application engine 110 fulfills one of multiple functions. For example, if the last word typed begins with one of the action indicators (also referred to as tag characters (@ or # or !), then the application engine 110 fulfills the autocomplete function. Otherwise, the application engine 110 may cause a search function to be performed on the text input.

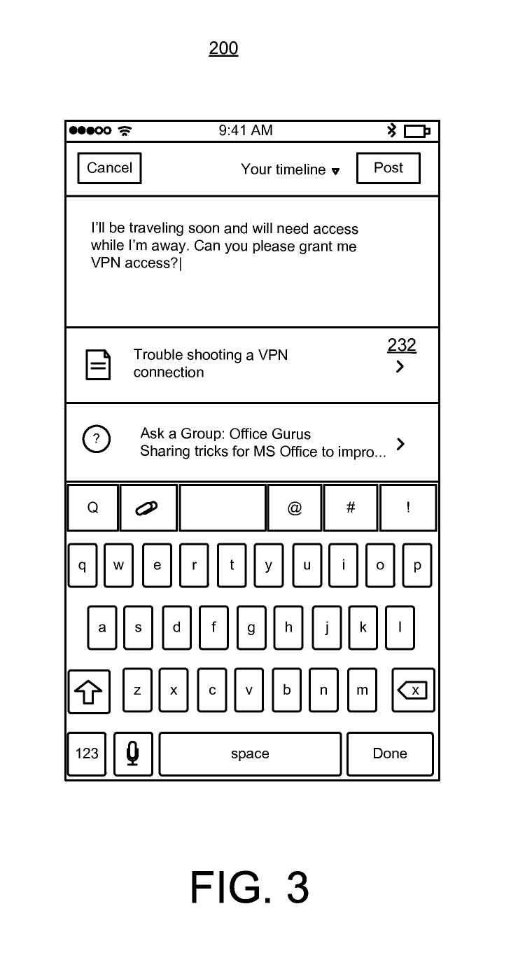

In the example of FIG. 2, the user initially types a question into the text input box 230. As discussed, the application engine 110 processes the text as it is typed. Referring to FIG. 3, the application engine 110 provides a response in the response area 232. When the search function returns a list of support objects to the client, the client user interface 200 renders the list on the screen below the Superbox (with profile pictures). If the user selects one of the support objects from the list, the client user interface navigates to the profile page for that object. From the profile page, the user can take various actions available for that Support Object or type of object.

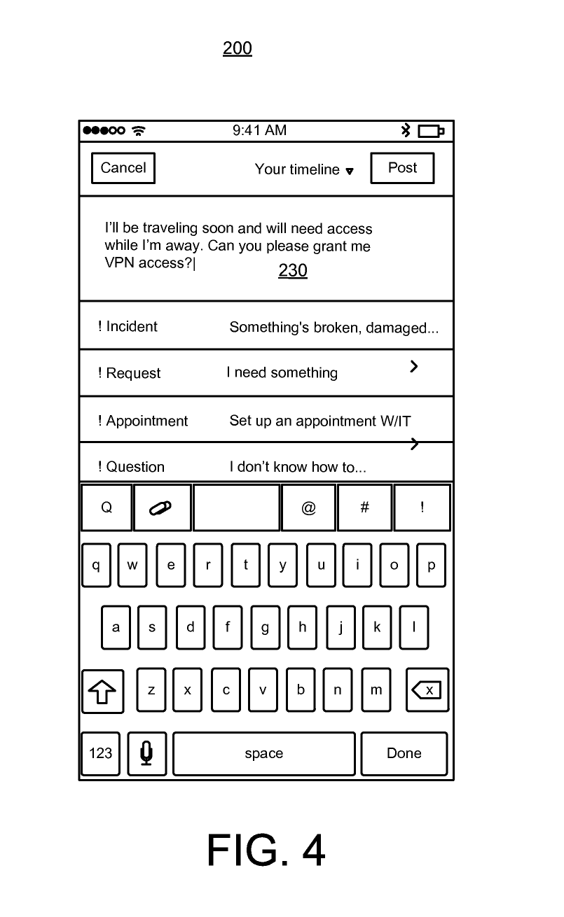

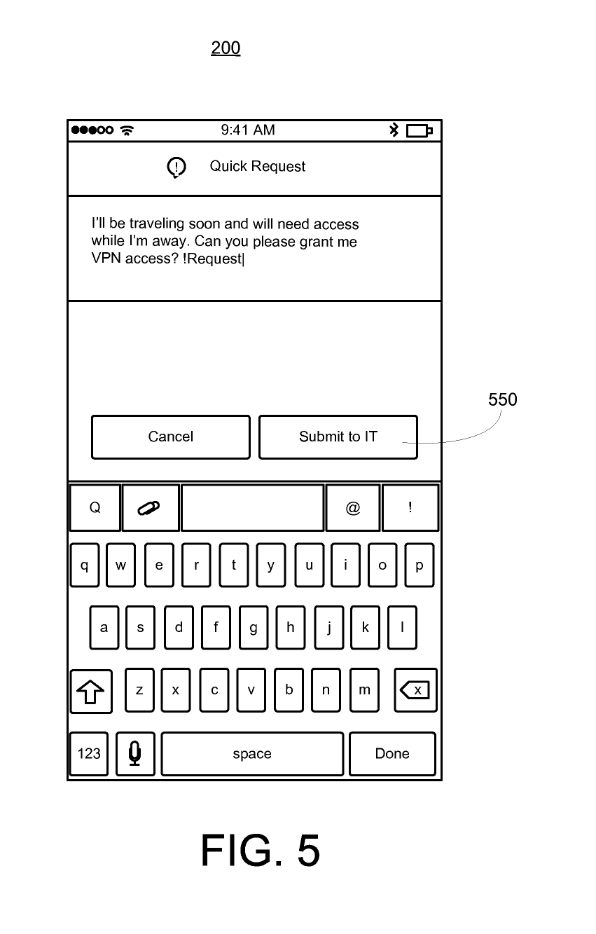

Referring to FIGS. 4 and 5, when the ‘!’ tag character 248 is used, the word used with it (such as “!Request”) is interpreted by the UI 200 as an action to take, and the UI 200 transforms to indicate an action to be taken, with buttons appropriate to the action and options for that action. For example, for !Request, a button would be labelled “Submit to IT” 550.

When the user indicates she is done with the overall entry by pushing the submit button 550 (or other button according to actions associated with the ‘!’ tag as indicated above), the client 108 sends a “submit” action along with the full text from the text input box 230 to the application engine 110. The application engine 110 receives the request and the application engine 110 then fulfills the text input box 230 submit function.

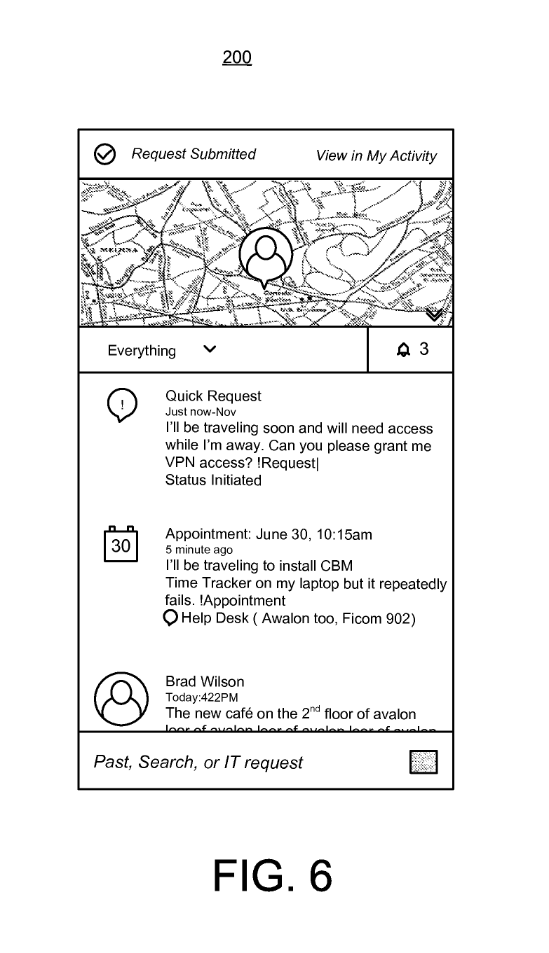

Referring to FIG. 6, the application engine 110 returns a request submitted success and verification message. In the example user interface 200, the submitted request is acknowledged and is listed along with other user information including appointments and communications.

Autocomplete Function

Based on which tag character was used on the last word in the text, the application engine 110 finds a list of objects to send back to the client. This last word is the target of the autocomplete. The list will be used by the client to show the list to the user and allow the user to easily pick one of the items from the list. The client then fills in that word to complete the word the user had started typing, and adds a space. It also adds an ID reference to the object into the text, but invisible to the user by means of a markup convention using special characters that can be interpreted by the UI and the server. The list is shown below the text input box 230 in the response area 232, and shows various fields such as name, description, and profile image if there is one. Each item also has the ID associated but not visible to the user. That way if multiple items have the same name they can still be distinguished by the system, by their ID values. If there is only one object in the list, the client automatically fills in that item in the text input box 230 without the user needing to select from the list.

To fulfill this function, the application engine 110 uses the search engine 112 to search the database of support objects 114. The tag character used for the word determines the type of object to search. All searches are by name (every Support Object has a Name property). For ‘@’, the types of objects searched are Person and Resource. For ‘#’, the type is Category. For ‘!’, the type is Support Function. For this, the application engine 110 calls the search engine 112 directly, specifying the type of object to search and the qualification, which is that the Name field starts with the text of the (possibly partial) target word. The search engine 112 returns the object list to the application engine 110, and the application engine 110 sends the list of names to the client user interface 108 for the autocomplete.

Search Function

Tagged words are sent to the search engine 112. A search is done similarly to the one for autocomplete. Search results as an object list are sent back to the application engine 110.

The full text input is sent to the Natural Language Processing Engine (NLP) 116. The NLP 116 returns a tree structure of important words (subject and predicates of phrases and other standard NLP word types) along with the part of speech for each word. Overly common or semantically insignificant words such as “a” and “the” are not in the result. The application engine 110 sends this parsed result to the search engine 112, which does a full-text search on support objects 114 in the system. A full-text search is different from the autocomplete search and matches words from the NLP 116 result to any and all properties of Support Objects, not only the Name property. The search engine 112 can rank results based on the quality of the match (matching a lot or a little of the text).

The results from both the tagged words search and the full-text search are sent to the prioritization engine 118. Also, the NLP result is sent. The prioritization engine 118 stores statistics on the words in the NLP result both for that user and overall. These statistics are available for the prioritization engine 118 to use in future uses of the Prioritization Function. The prioritization engine 118 then performs the prioritization function. This results in a list of Support Object which contains the objects in the list sent from the application engine 110, but ordered and ranked based on expected relevance based on the prioritization performed by the prioritization function. These results are then sent back to the application engine 110 which sends them on to the client user interface 108 as the result of the text input.

Prioritization Function

The prioritization engine 118 uses statistics on the words in the NLP result from previous searches (both for that user and all users overall) that are stored in database 120; statistics on Support Object profiles viewed by that user and all users overall; and other information about that user (department, role), to determine the most relevant objects in the list, and then sorts the list and gives ranking to each item.

Submit Function

The client user interface 108 sends the action to the application engine 110, which is either “submit” if the ‘!’ tag is not used, or a different specific action if the ‘!’ tag was used, corresponding to an action button mentioned in the overall behavior section. For a generic “submit”, a social post is created. For other actions, the appropriate configurable action is taken by the application engine 110. For instance the “submitservicerequest” action associated with the !Request tag submits a Service Request to the Service Desk via integration with that system.

For actions other than the generic “submit” (social post), keywords and phrases are matched to various parameter values available for the action. The post is searched for these keywords and phrases, and the presence of them indicates certain parameter values that the application engine 110 automatically fills in. Specifically, for Service Requests or Incidents (the “!Incident” tag), certain keywords or phrases indicate certain values for the “impact”, “priority” and three CTI fields which are standard in Service Desk/IT Service Management products. CTI is an industry standard term for a standard classification method consisting of three fields on an Incident or Service Request, forming a three-tiered classification: Category, Type (each value associated with a Category), and Item (each value associated with a Type).

Examples of the keywords or phrases mapped for Incident and Service Request actions:

“critical”: Impact=Widespread, Priority=Critical

“laptop” and “problem”: CTI=PC->laptop

In addition, the application engine 110 can use data about the user (context) coming from the support objects database 114 to know more information. For the above example of a laptop problem, the CTI will indicate to the application engine 110 to look at the Resources owned by the User for a PC/laptop, and find that it is a Dell brand, according to the CTI of the resource itself, and add that as the “Item” in the CTI.

Corresponding to the user context added to the action, in all cases any location information provided by the user to the application, or allowed by the user to be accessed from the underlying operating system, is associated with the action for use by corporate service support staff receiving the action.

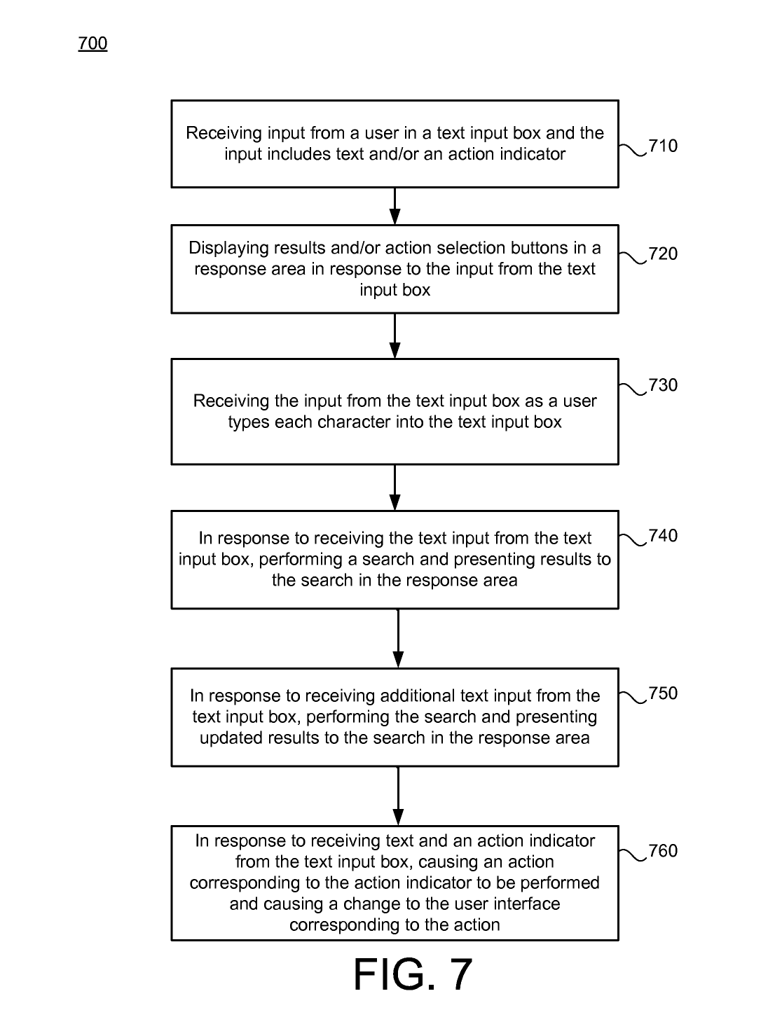

Referring to FIG. 7, an example flowchart illustrates an example process 700 for example operations of the system 100 of FIG. 1. For example, process 700 includes receiving input from a user in a text input box and the input includes text and/or an action indicator (710). For example, the user client/user interface 108 may receive input from a user in a text input box (e.g., text input box 230 of FIG. 2), where the input includes text and/or an action indicator.

Process 700 includes displaying results and/or action selection buttons in a response area in response to the input from the text input box (720). For example, the user interface 108 may display results and/or action selection buttons (e.g., action indicator selection area 234 of FIG. 2) in a response area (e.g., response area 232 of FIG. 2) in response to the input from the text input box.

Process 700 includes receiving the input from the text input box as a user types each character into the text input box (730). For example, the application engine 110 may receive the input from the text input box as the user types each character into the text input box (730).

Process 700 includes performing a search and presenting results to the search in the response area, in response to receiving the text input from the text input box (740). For example, the application engine 110 may communicate the input to the search engine 112 to perform a search, where the results of the search are provided back to the user client/user interface 108 for display in the response area 232 through the application engine 110.

Process 700 includes, in response to receiving additional text input from the text input box, performing the search and presenting updated search results to the search in the response area (750). For example, the application engine 110 may receive additional text from the text input box and communicate the additional text to the search engine 112 to perform the search on the additional text and then to present the updated search results for display in the response area.

Process 700 also include, in response to receiving text and an action indicator from the text input box, causing an action corresponding to the action indicator to be performed and causing a change to the user interface corresponding to the action (760). For example, the application engine 110 may cause a change to the user interface 200 of FIG. 2 based on the received text and an action indicator from the text input box.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

For example, the user client/user interface 108 may be any type of computing device that includes at least one processor, at least one non-transitory memory for storing instructions, including an application having instructions, that may be executed by the at least one processor to perform the functions described above. Similarly, the application engine 110, the search engine 112, the NLP engine 116, the prioritization engine 118, the support objects database 114 and the search history and user context database 120 may be implemented on one or more computing devices that includes at least one processor, at least one non-transitory memory for storing instructions, including an application having instructions, that may be executed by the at least one processor to perform the functions described above.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system, comprising:
a user interface implemented on a first computing device, wherein the user interface includes:
a text input box configured to receive input from a user and the input includes text and/or an action indicator, and
a response area for displaying results and/or action selection buttons in response to the input from the text input box; and
an application engine implemented on a second computing device, wherein the application engine is configured to:
receive the input from the text input box as a user types each character into the text input box,
in response to receiving the text input from the text input box, perform a search and present results to the search in the response area as the user types into the text input box,
in response to receiving additional text input from the text input box, perform the search and present updated results to the search in the response area, and
in response to receiving text and an action indicator from the text input box, cause an action corresponding to the action indicator to be performed and cause a change to the user interface corresponding to the action.

2. The system of claim 1 wherein the application engine is configured to:
in response to receiving text only without an action indicator and a submit action, post the text to a social media platform.

3. The system of claim 1 further comprising a search engine and a database of support objects, wherein the application engine is configured to:
in response to receiving the action indicator attached to specific text, cause the search engine to search a list of objects from the database of support objects based on the specific text and present the list of objects for display in the response area of the user interface and selection by the user.

4. The system of claim 3 wherein the application engine is configured to auto-complete the specific text with a name of the object associated with the action identifier and assign an identifier to the name of the object for use by the application engine, wherein the identifier is hidden from the user.

5. The system of claim 3 wherein the action indicator determines a type of object for the search engine to search for in the database of support objects.

6. The system of claim 5 wherein the type of object includes a name object, a category object and a support object, wherein each of the objects corresponds to a different action indicator.

7. The system of claim 3 further comprising a natural language processing (NLP) engine, wherein:
the application engine sends the text input to the NLP engine,
the NLP engine is configured to return a tree structure of words, and
the search engine is configured to search the database of support objects using the tree structure of words.

8. The system of claim 7 further comprising a prioritization engine, wherein:
the prioritization engine is configured to receive results from the search engine and to prioritize the results to order and rank the results, and
the application engine is configured to cause the ordered and ranked results to be displayed in the response area of the user interface.

9. The system of claim 8 further comprising a search history and user context database, wherein the prioritization is configured to use information from the search history and user context database to order and rank the results.

10. A computer-implemented method including executing instructions stored on a non-transitory computer-readable storage medium, the method comprising:
receiving input from a user in a text input box and the input includes text and/or an action indicator;
displaying results and/or action selection buttons in a response area in response to the input from the text input box;
receiving the input from the text input box as a user types each character into the text input box;
in response to receiving the text input from the text input box, performing a search and presenting results to the search in the response area input;
in response to receiving additional text input from the text input box, performing the search and presenting updated results to the search in the response area; and
in response to receiving text and an action indicator from the text input box, causing an action corresponding to the action indicator to be performed and causing a change to the user interface corresponding to the action.

11. The computer-implemented method of claim 10 further comprising:
in response to receiving text only without an action indicator and a submit action, posting the text to a social media platform.

12. The computer-implemented method of claim 10 further comprising:
in response to receiving the action indicator attached to specific text, causing a search engine to search a list of objects from the database of support objects based on the specific text and presenting the list of objects for display in the response area of the user interface and selection by the user.

13. The computer-implemented method of claim 12 further comprising:
auto-completing the specific text with a name of the object associated with the action identifier and assigning an identifier to the name of the object for use by the application engine, wherein the identifier is hidden from the user.

14. The computer-implemented method of claim 12 further comprising:
determining a type of object for the search engine to search for in the database of support objects.

15. The computer-implemented method of claim 14 wherein the type of object includes a name object, a category object and a support object, wherein each of the objects corresponds to a different action indicator.

16. The computer-implemented method of claim 12 further comprising:
sending the text input to a natural language processing (NLP) engine;
returning a tree structure of words by the NLP engine; and
searching the database of support objects using the tree structure of words by the search engine.

17. The computer-implemented method of claim 16 further comprising:
receiving results at a prioritization engine from the search engine and prioritizing the results to order and rank the results; and
causing the ordered and ranked results to be displayed in the response area of the user interface.

18. The computer-implemented method of claim 17 further comprising:
ordering and ranking the results using information from a search history and user context database.

19. A computer program product tangibly embodied on a non-transitory computer-readable storage medium and including executable code that, when executed, is configured to cause at least one processor to:
receive input from a user in a text input box and the input includes text and/or an action indicator;
display results and/or action selection buttons in a response area in response to the input from the text input box;
receive the input from the text input box as a user types each character into the text input box;
in response to receiving the text input from the text input box, perform a search and present results to the search in the response area input is received into the text input box;
in response to receiving additional text input from the text input box, perform the search and present updated results to the search in the response area; and
in response to receiving text and an action indicator from the text input box, cause an action corresponding to the action indicator to be performed and cause a change to the user interface corresponding to the action.

20. The computer program product of claim 19 further comprising executable code that, when executed, is configured to cause at least one processor to:
in response to receiving text only without an action indicator and a submit action, post the text to a social media platform.
